(19) United States
(12) Patent Application Publication
(10) Pub. No.: US 2003/0183101 A1
(43) Pub. Date: Oct. 2, 2003

(54) Printing ink pumping system

(76) Inventor: Michael Owen, Richmond, VA (US)

Correspondence Address: RONALD B. SHERER, 103 SOUTH SHAFFER DRIVE, NEW FREEDOM, PA, 17349, US

(21) Appl. No.: 10/113,046

(22) Filed: Apr. 1, 2002

(51) Int. Cl. B41F 31/02

(52) U.S. Cl. 101/366

(57) ABSTRACT

A pumping system, such as for supplying ink in a printing machine, is disclosed in which the duration of the pump discharge is substantially longer than the duration of the intake to the pump.

### BACKGROUND

It is well known that ink may be supplied to one or more rotary printing stages by the use of diaphram pumps such as disclosed for example in U.S. Pat. No. 5,003,876 which is hereby incorporated by reference. However, such pumps are expensive and they do not deliver the ink to the fountain in a smooth or even flow. Instead, each pumping movement of the diaphram produces a slug of ink. This is undesirable, and often causes the ink to foam which is most undesirable.

### SUMMARY

The above-indicated problems have been solved by the controlled use of a positive displacement pump such as to draw ink from a reservoir relatively quickly followed by a relatively slow and uniform discharge of the ink to the fountain.

### DRAWINGS

FIG. 1 is a schematic side elevational view of a typical multi-stage rotary printing machine;

FIG. 2 is a schematic diagram of the ink system of one stage of the machine;

FIG. 3 is a side elevational view of one embodiment of a pump which may be used in the present invention;

FIGS. 4A and 4B are schematic illustrations of a second embodiment of a pump which may be used in the present invention; and

FIG. 5 is a schematic diagram of one preferred control system for operating the pump in the desired mode of the present invention.

### DETAILED DESCRIPTION

FIG. 1 schematically illustrates a multi-stage rotary printing machine 10, such as a flexographic printing machine for printing multi-colored images on individual sheets of material such as, for example, blanks 16 of corrugated cardboard for creating end displays and containers. The typical machine includes a feed section 12, four printing sections 14, 16, 18 and 20, a die cutter section 22 and a slotting-scorer section 24, although many other combinations of sections may be used.

It will be understood that each printing stage prints a different color on the sheets passing through, and that each stage includes a printing cylinder 30 and an impression cylinder 28 between which sheets 16 are conveyed by rollers 26, or by transfer conveyor belts as is well known. Each of the printing stages includes an ink fountain, schematically shown as element 36, which applies controlled amounts of ink to an ink roll 32 which is preferably an anilox roll for flexographic printing. In addition, each printing stage may include a wipe roll 34 if desired or required for certain types of printing. It will be understood that each fountain 36 must be supplied with an ink of a predetermined color, and that each of the inks must be supplied to the fountains in a timely manner and in a controlled amount so as to be applied uniformly to each of the ink rolls and then to each of the printing cylinders.

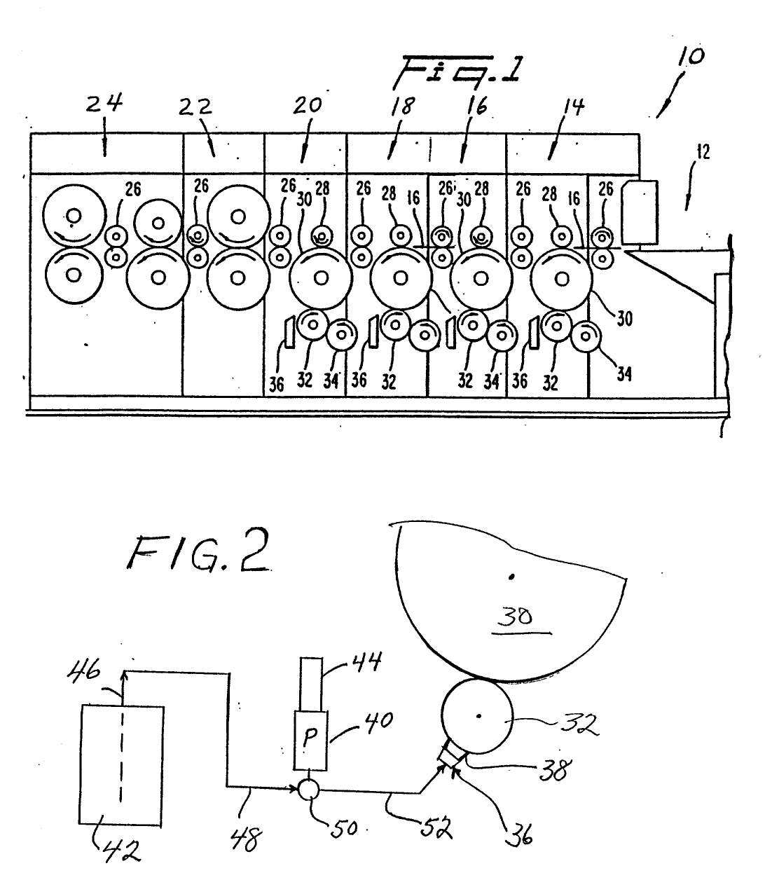

FIG. 2 schematically illustrates the ink pumping system of the present invention for supplying ink to each of the printing stages of the printing machine. Each of such stages includes the conventional printing elements as just described including and an ink fountain 36 with doctor blades shown schematically at 38. As further illustrated schematically in FIG. 2, each ink system includes an ink storage tank 42 which contains several gallons, such as 1-10, of ink of one particular color; such storage tank also being referred to hereafter as a reservoir. Thus, the storage tank or reservoir need only be re-filled occasionally, whereas the ink fountain must be kept full by frequent or continuous filling. In the present invention, between storage tank 42 and fountain 36 is a positive displacement pump 40 driven by an actuator 44 or fluid motor. Pump 40 draws ink through dip tube 46, line 48 and reversing valve 50 into the pumping chamber of the pump. Pump 40 then discharges the ink through line 52 to the ink fountain. Pump 40 may be a standard dual stroke type, but the ink is discharged in a unique manner as will be more fully described hereafter.

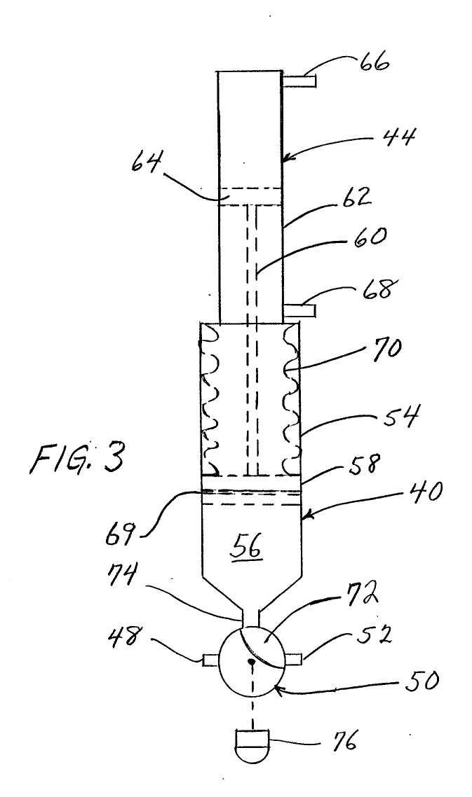

As shown in FIG. 3, pump 40 includes a housing 54 which may be formed of a low-cost plastic tube such as PVC. Housing 54 defines a variable volume pumping chamber 56 positioned below a piston 58 having a piston rod 60. Rod 60 extends into the pneumatic or hydraulic motor or power cylinder 44. Motor 44 includes a housing 62, a piston 64 and two ports 66, or lines 68 positioned on opposite sides of piston 64.

With respect to sealing pump piston 58, various sealing means may be used such as a piston ring 69. However, a flexible bellows 70 is preferred. The lower end of bellows 70 is sealed to piston 58 and the upper end is sealed to the upper end of housing 54. It will also be noted that, preferably, the lower end of housing 54 forming the discharge from chamber 56 is curved or tapered so as to promote the smooth flow of the ink.

The discharge of the pump is preferably connected directly to reversing valve 50 such that the pump and valve form an integral unit. However, if desired for some reason, the discharge may be connected to the valve through a pipe or flexible tubing. It will be readily understood that reversing valve 50 may take various forms such as a pair of check valves for example. However, it is preferred that it be a rotary valve as illustrated. The valve includes a passage 72 which connects valve inlet 74 to discharge line 52, or to inlet line 48 when the valve is rotated by its actuator 76.

Operation

The details of one preferred control system for controlling the pump will be described hereafter. However, the unique operation of the pump will now be described in terms of the functional results of the ink system.

As shown in FIGS. 2 and 3, when it is desired to transfer a predetermined amount of ink from tank 42 to fountain 36, pressurized fluid such as compressed air is admitted to power cylinder 44 through port 68 so as to drive pistons 58 and 64 upwardly. This maximizes the volume of pumping chamber 56, and therefore draws ink from reservoir 42, through dip tube 46 and line 48 and valve 50 into pumping chamber 56. This movement and enlargement of the pumping chamber is performed quickly such as in the range of about one to five seconds, and preferably for example, in the range of about one to three seconds. Immediately thereafter, pressurized fluid is supplied to port 66 and the fluid below piston 64 is allowed to vent through line 68 and vent line 92. However, vent line 92 is restricted by a restictor 94 as will be further explained with reference to the control system illustrated in FIG. 5. Also, it will be understood that, in one embodiment, the pressure of the fluid supplied to line 66 to force the pump piston downwardly may be selected to be substantially less that the pressure supplied to line 68 to raise piston 58 quickly. Thus, by whichever means, pump piston 58 is driven upwardly so as to expand pump chamber 56 at a substantially faster rate than the rate at which it is slowly and uniformly forced downwardly to produce a steady and controlled rate of flow of the ink through line 52 to the fountain.

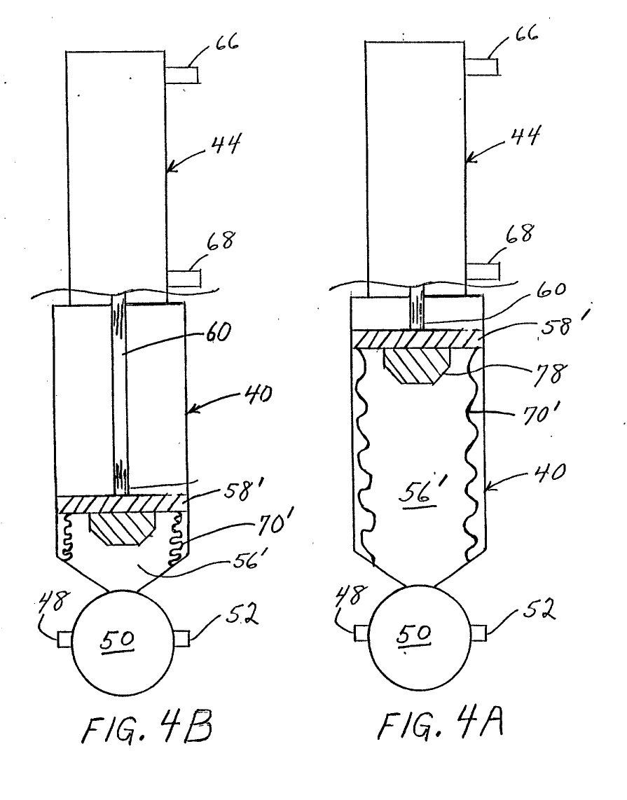

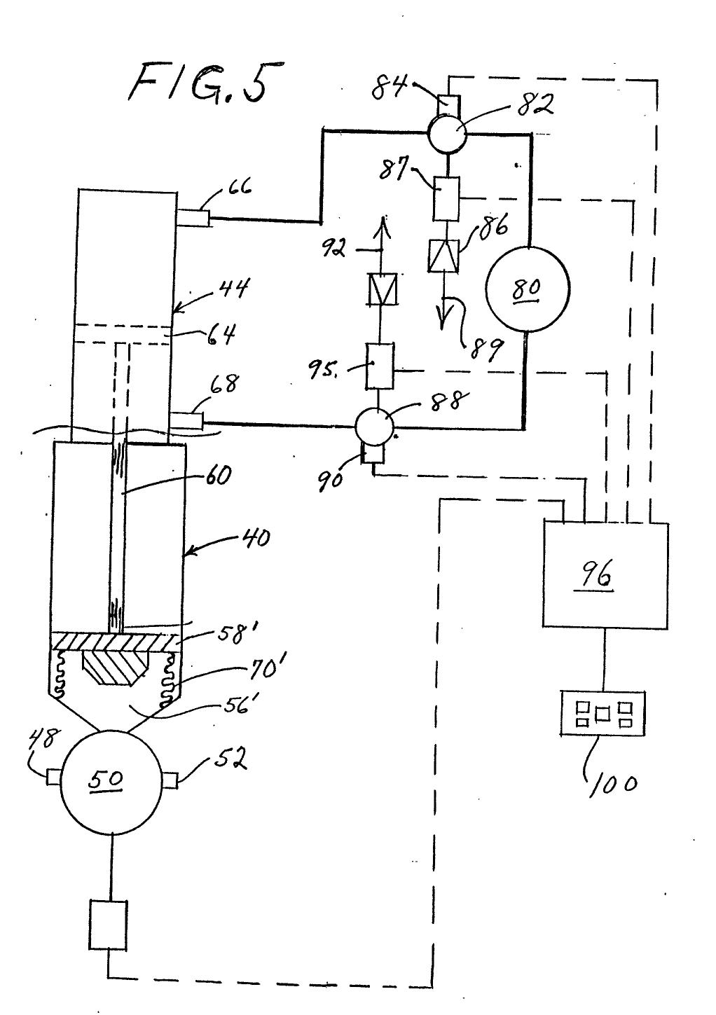

An alternative preferred embodiment of the pump will now be described with respect to FIGS. 4A and 4B. The numerals applied to the FIGS. 4A-B embodiment represent the same elements in the FIG. 3 embodiment and thus do not need repeated description. However, pump piston 58′ and bellows 70′ are arranged differently. For example, bellows 70′ is connected and sealed at its upper end to the bottom periphery of piston 58′ such as to enclose the piston and move with the piston. As a result, no piston seal or other additional seals are required since the ink is always confined within the bellows. In addition, it is preferred that the minimum volume of chamber 56′ be made almost zero by providing a volume reducer element 78 connected to the bottom of piston 58′. The pumping chamber may then be emptied virtually completely on each discharge stroke.

One preferred embodiment of a control system will now be described with reference to FIG. 5 wherein the same reference numerals refer to the same elements as previously described. Numeral 80 represents a source of pressurized fluid such as hydraulic fluid or compressed air. Compressed air is preferred since a compressor and high pressure tank are commonly available for supplying compressed air to operate other elements of printing machines. Also, the air may be vented to atmosphere whereas hydraulic fluid must be maintained in a closed system. Therefore, the following description will assume that air is the motive fluid. A two position valve 82 is located in line 66 and is controlled by an actuator 84. For example, elements 82 and 84 may be a unitary solenoid valve. In one position, valve 82 supplies the pressurized air to cylinder 44 through line 66 so as to force piston 64 downwardly. In its other position, valve 82 vents the air through vent line 89. Similarly, line 68 includes a two position valve 88 which includes an actuator 90 which may constitute a solenoid actuated valve, for example. In one position valve 88 supplies fluid to power cylinder 44 through line 68 so as to force piston 64 upwardly. In its other position, valve 88 vents the air through vent line 92.

While other controls are possible, the illustrated embodiment further includes a limit switch 95 and a restrictor 94 in line 92. Switch 95 sends a signal to a controller 96 which preferably is a programmable logic controller, or PLC. Restrictor 94 creates a back pressure in line 92 and restricts the flowrate so as to constitute a choke in line 92. Therefore, the flowrate through line 92 is controlled so as to vent the air below piston 64 very slowly, and hence, establish a relatively slow movement of pump piston 58 downwardly on the discharge stroke of the pump. As illustrated, switch 92 is a pressure actuated switch responsive to the pressure in line 92. Alternatively, a mechanical switch operated by piston 64 may be used.

As further illustrated in FIG. 5, line 89 includes a restrictor 86 and a limit switch 87. Restrictor 86 is sized so as to only produce a slight backpressure in line 89 and not to significantly reduce the flowrate through vent line 89. Switch 87 sends s signal to PLC 96 as will be further described. As also shown in FIG. 5, two position valve 50 is actuated by an actuator 76 which may be a solenoid actuated valve similar to valves 82 and 88 previously described. Therefore, in summary, switches 87 and 95 send signals to PLC 96 which indicate the pressures in lines 82 and 92, and therefore, the position of piston 64 at its upper most position for drawing ink into chamber 56, and its lowermost position when chamber 56 has been discharged. As a result of the signals received, PLC 96 sends signals to actuators 84, 90 and 76 to position valves 82, 88 and 50, respectively. In addition, a manual input 100 may be provided to PLC 98 if desired in order to override switches 87 and 95 and program a longer or shorter cycle as may be desired in a particular application.

The detailed operation of the system is as follows. When pressure switch 95 and controller 96 determine that pump 40 is at its full discharge stroke, controller 96 signals actuator 90 to open valve 88 and admit high pressure fluid to power cylinder 44 through line 68. The pressure of the fluid is selected such as to raise pistons 64 and 58 rapidly to their uppermost positions. This maximizes the volume of pumping chamber 56 and draws ink into the enlarged pumping chamber from reservoir 42 in a matter of seconds. Immediately thereafter, controller 96 moves valve 88 to its other or vent position, and actuator 84 is simultaneously actuated to open valve 82 and supply pressurized fluid through line 66. At the same time, fluid is vented from below piston 64 through line 68, but it is vented slowly through restrictor 94 so that pistons 64 and 58 move downwardly at a slow and steady rate. This discharges the ink through line 52 to the ink fountain in a slow, steady and uniform flowrate such that the ink slowly fills the fountain without turbulence or foaming or overfilling. This discharge of the ink is controlled and continues for the desired time which may be 5 to 10 minutes or more. When pump piston 58 reaches its full discharge position as determined by switch 87, controller 96 actuates valves 82 and 88 to reverse the direction of pistons 58 and 64 so that the cycle is repeated. Depending upon the particular printing conditions, controller 96 may be set or changed in order to provide the optimum cycle time for that condition by inputting the desired cycle time through keyboard 100.

From the foregoing description of several preferred embodiments of the present invention, it will be understood that many modifications and variations will be apparent to those skilled in the art. For example, it will be apparent that the invention may employ actuators operated pneumatically or hydraulically. It will also be understood that a manually set timer may be substituted for or used with PLC 96. Also, pressure responsive switches 87 and 95 may be mechanically actuated switches and be positioned within cylinder 44 so as to be actuated by piston 64. Accordingly, it is to be understood that the foregoing description of several preferred embodiments is intended to be illustrative rather than exhaustive of the principles of the invention, and that the scope of the invention is not intended to be limited other than as set forth in the following claims interpreted under the doctrine of equivalents.

What is claimed is:

1. A pumping system for supplying ink to a printing machine comprising:
(a) a printing machine including at least one ink fountain;
(b) a reservoir of ink;
(c) pumping means connected to said reservoir and to said fountain for supplying ink from said reservoir to said fountain;
(d) said pumping means including a pump having a pumping chamber; and
(e) control means for rapidly increasing the volume of said pumping chamber for rapidly drawing ink into said chamber from said reservoir and for relatively slowly reducing the volume of said pumping chamber for flowing ink to said fountain at a rate substantially slower than the rate of drawing ink into said chamber.

2. The pumping system of claim 1 wherein said control means include a controller of the PLC type.

3. The pumping system of claim 1 including a fluid motor for driving said pump, and restrictor means for controlling the flow of ink from said pumping chamber to said fountain.

4. The pumping system of claim 3 wherein said restrictor means produce a non-foaming stream of ink to said fountain.

5. The pumping system of claim 3 wherein said restrictor means produce a stream of substantially uniform pressure to said fountain.

6. The pumping system of claim 3 wherein said restrictor means produce a non-foaming and substantially uniform pressure stream of ink to said fountain.

7. The pumping system of claim 3 wherein said control means include first and second switches responsive to the intake and discharge of said pump.

8. The pumping system of claim 7 including an actuating cylinder connected to said pump, and wherein said switches are responsive to the pressures in said fluid motor.

9. A pumping system for supplying a liquid to a receiver at a controlled rate comprising:
(a) a reservoir of fluid;
(b) a receiver for said fluid;
(c) a positive displacement pump having an inlet connected to said reservoir and an outlet connected to said receiver; and
(d) control means for rapidly drawing said liquid into said pump at a predetermined rate and for discharging said liquid from said pump at a rate substantially slower than said predetermined rate.

10. The pumping system of claim 9 wherein said liquid is printing ink and said receiver is an ink fountain in a printing machine.

11. The pumping system of claim 9 wherein said control means include a pair of switches which are actuated at the beginning and end of each stroke of said pump.

12. The pumping system of claim 11 wherein said pair of switches comprise pressure responsive switches.

13. A method of operating a pump for supplying ink to a reservoir in a printing machine comprising:
(a) operating said pump to draw ink into said pump at a given flow rate; and
(b) operating said pump to discharge said ink at a flowrate substantially less than said given flowrate.

14. The method of claim 13 in which said pump is driven by a power cylinder having a piston, and the position of said piston is sensed as an indication of the times of the intake and discharge and discharge strokes of said pump.

15. A pump for pumping a liquid from a reservoir to a receiver comprising:
(a) a positive displacement pump having a housing, a pumping member and a pumping chamber;
(b) actuator means connected to said pump for moving said pumping member from an intake position to a discharge position; and
(c) controller means for varying the duration of the intake of said pump relative to the discharge of said pump.

16. The pump of claim 15 wherein said controller means produce a substantially longer duration of discharge of said pump relative to the duration to the intake of said pump.

17. The pump of claim 15 wherein said pumping member comprises a piston, and said piston is sealed to said housing by a flexible bellows.

18. The pump of claim 17 wherein said bellows forms said pumping chamber.

19. The pump of claim 15 wherein said liquid is ink and said receiver is an ink fountain in a printing machine.

20. The pump of claim 15 wherein said actuator means comprise a fluid motor, and including a pair of switch means for sensing the position of said pumping member.
